(19) United States
(12) Patent Application Publication
(10) Pub. No.: US 2025/0184657 A1
(43) Pub. Date: Jun. 5, 2025

(54) ELECTRONIC DEVICE COMPRISING AUDIO INPUT DEVICE

(71) Applicant: SAMSUNG ELECTRONICS CO., LTD., Suwon-si (KR)

(72) Inventors: Sukgyong KIM, Suwon-si (KR); Jonghwan Kim, Suwon-si (KR); Changmin Kim, Suwon-si (KR); Hakhoon Song, Suwon-si (KR)

(73) Assignee: SAMSUNG ELECTRONICS CO., LTD., Suwon-si (KR)

(21) Appl. No.: 19/048,443

(22) Filed: Feb. 7, 2025

Related U.S. Application Data
(63) Continuation of application No. PCT/KR2023/010874, filed on Jul. 26, 2023.

(30) Foreign Application Priority Data
Aug. 8, 2022 (KR) 10-2022-0098855
Sep. 8, 2022 (KR) 10-2022-0114409

(51) Int. Cl. H04R 1/28; G06F 1/16; G06F 1/18; H04R 19/04

(52) U.S. Cl. CPC H04R 1/2807; G06F 1/1605; G06F 1/183; H04R 19/04; H04R 2201/003; H04R 2499/11

(57) ABSTRACT

An electronic apparatus includes: a housing includes a hole; and an audio input device in the housing and includes a substrate and micro electro mechanical systems (MEMS). The substrate includes: a through hole through which sound waves transmitted from the hole of the housing pass, and a seating groove that is spaced apart from a periphery of the through hole, the seating groove being dented from a surface of the substrate. The MEMS includes: a side wall, a diaphragm, and a plate. A resonant frequency of the audio input device is adjusted based on a volume of a first space surrounded by the surface, the side wall, and the diaphragm.

### CROSS-REFERENCE TO RELATED APPLICATIONS

This application is a by-pass continuation application of International Application No. PCT/KR2023/010874, filed on Jul. 26, 2023, which is based on and claims priority to Korean Patent Application No. 10-2022-0098855, filed on Aug. 8, 2022, and Korean Patent Application No. 10-2022-0114409, filed on Sep. 8, 2022, in the Korean Intellectual Property Office, the disclosures of which are incorporated by reference herein their entireties.

### BACKGROUND

### 1. Field

The disclosure relates to an electronic apparatus comprising an audio input device.

### 2. Description of Related Art

The electronic device may include an audio input device (e.g., a microphone). The audio input device may convert an analog audio signal (e.g., sound waves) received from the outside of the electronic device into an audio signal that is an electrical signal. The audio signal may be outputted to the outside of the electronic device through an audio output device (e.g., a speaker).

The above-described information may be provided as related art for the purpose of helping understanding of the disclosure. No argument or decision is made as to whether any of the above description may be applied as a prior art related to the disclosure.

### SUMMARY

According to an aspect of the disclosure, an electronic device includes: a housing including a hole; and an audio input device, disposed in the housing, comprising a substrate and micro electro mechanical systems (MEMS), wherein the substrate comprises: a through hole through which sound waves transmitted from the hole of the housing pass, and a seating groove that is spaced apart from a periphery of the through hole, the seating groove being dented from a surface of the substrate, and wherein the MEMS includes: a side wall disposed on the seating groove of the substrate, a diaphragm supported by the side wall of the MEMS and spaced apart from the surface of the substrate in a direction where the surface faces, and a plate including a plurality of holes, the plate being supported by the side wall of the substrate and spaced apart from the diaphragm in the direction, and wherein a resonant frequency of the audio input device is adjusted based on a volume of a first space surrounded by the surface of the substrate, the side wall of the MEMS, and the diaphragm of the MEMS.

A portion of the substrate between the seating groove of the substrate and the through hole of the substrate may occupy a portion of a space surrounded by the diaphragm of MEMS and the side wall of MEMS.

The audio input device may further include a cover, disposed on the surface of the substrate, surrounding the side wall of the MEMS and the plate of the MEMS.

The audio input device may further include: the first space, and a second space surrounded by the surface of the substrate, the cover of the audio input device, and the MEMS, and wherein a volume of the first space is smaller than a volume of a third space surrounded by a bottom surface of the side wall of the MEMS, a lateral surface of the side wall of the MEMS, and the diaphragm.

A volume of the second space may be increased as the side wall is inserted into the seating groove of the substrate.

The seating groove of the substrate may surround the through hole of the substrate, and wherein the side wall may surround the through hole of the substrate by being inserted into the seating groove of the substrate.

The electronic device may further includes an adhesive between the seating groove of the substrate and the side wall of the MEMS, wherein the adhesive may attach the side wall of the MEMS to the seating groove of the substrate.

A volume of the space may be maintained constantly by adjusting a height of the seating groove of the substrate based on a size of the diaphragm.

The housing may further include a duct configured to transmit sound waves introduced into the hole of the housing to the through hole of the substrate by connecting the hole of the housing and the through hole of the substrate.

The housing may further include a printed circuit board (PCB), wherein the substrate may be on the PCB, and wherein the PCB may include a first opening, the PCB being positioned at a position corresponding to the through hole of the substrate and being connected to the duct of the housing.

The audio input device may further include a support that: is disposed on the surface of the substrate, occupies a portion of the space, and includes a second opening positioned at a position corresponding the through hole of the substrate, and wherein a volume of the space may be decreased by a volume of the support.

The support may be integrated with the side wall of the MEMS.

The volume of the space may be maintained constantly by adjusting the volume of the support based on a size of the diaphragm.

The electronic device may further include: a processor including processing circuitry; and memory including one or more storage mediums storing instructions, wherein the instructions, when executed by the processor, cause the electronic device to obtain an audio signal based on a change in electrostatic capacitance between diaphragm of the MEMS and the plate of the MEMS.

The audio input device may further include signal processing circuitry configured to generate the audio signal based on the change in the electrostatic capacitance, and wherein the signal processing circuitry may be configured to: generate the audio signal based on the change in the electrostatic capacitance, and transmit the audio signal to the processor.

According to an aspect of the disclosure, an electronic device includes: a housing including a hole; an audio input device including a substrate and micro electro mechanical systems (MEMS); wherein the substrate includes a through hole through which sound waves transmitted from the hole of the housing pass, and wherein the MEMS includes: a side wall on a surface of the substrate, a diaphragm supported by the side wall of the MEMS and spaced apart from the surface of the substrate in a direction where the surface faces, a plate including a plurality of holes, the plate being supported by the side wall of the substrate and spaced apart from the diaphragm in the direction, and a support between the through hole and the side wall on the surface, the support occupying a portion of a space between the diaphragm and the surface of the substrate and the support including an opening positioned at a position corresponding the through hole of the substrate, and wherein a resonant frequency of the audio input device is configured to be adjusted based on a volume of a space surrounded by the surface of the substrate, the side wall of the MEMS, the diaphragm of the MEMS, and the support.

The support may be integrally formed with the side wall.

The audio input device may further include: a cover on the surface of the substrate and surrounding the side wall of the MEMS and the plate of the MEMS, a first space defined by the side wall, the diaphragm, and the support, and a second space defined by the surface of the substrate, the cover, and the MEMS, and wherein a volume of the first space is smaller than a volume of a third space surrounded by a bottom surface of the side wall of the MEMS, a lateral surface of the side wall of the MEMS, and the diaphragm.

The volume of the space may be maintained constantly by adjusting a volume of the support based on a size of the diaphragm.

The housing may further include a duct configured to transmit the sound waves introduced into the hole of the housing to the through hole of the substrate, by connecting the hole of the housing and the through hole of the substrate.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to one or more embodiments;

FIG. 2 is a diagram illustrating an electronic device according to an embodiment;

FIG. 3 is an exploded perspective view of an electronic device according to an embodiment;

FIG. 4 is a cross-sectional view of an example electronic device cut along line A-A′ of FIG. 2;

FIG. 5A illustrates an example audio input device;

FIG. 5B is a plan view of an example substrate of an audio input device;

FIG. 6 illustrates an example audio input device;

FIG. 7A illustrates an example audio input device including a support;

FIG. 7B is a plan view of an example substrate of an audio input device;

FIG. 7C illustrates an example audio input device in which a support and a side wall are integrated;

FIG. 8 illustrates frequency response curves according to a volume of a front chamber of an audio input device; and

FIG. 9 illustrates an example audio input device;

### DETAILED DESCRIPTION

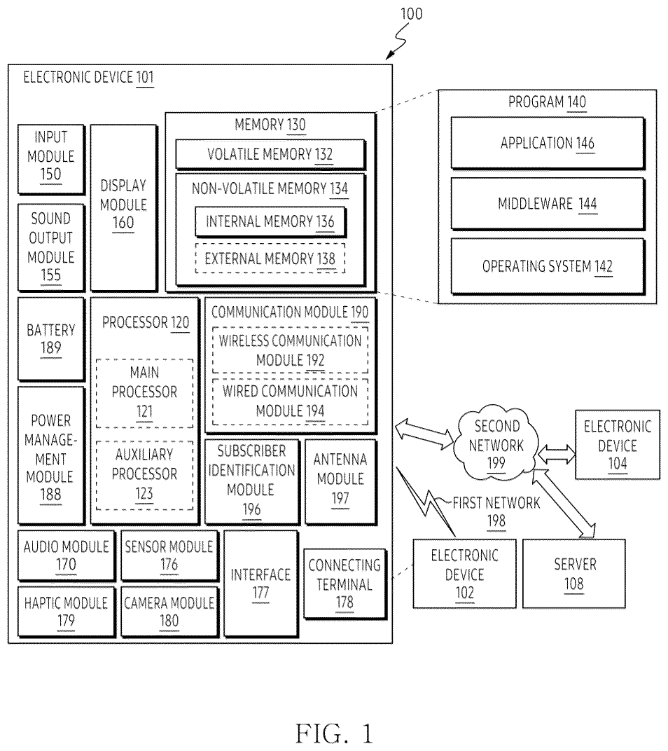

FIG. 1 is a block diagram illustrating an electronic device in a network environment according to one or more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 performs a function or a service automatically, or based on a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

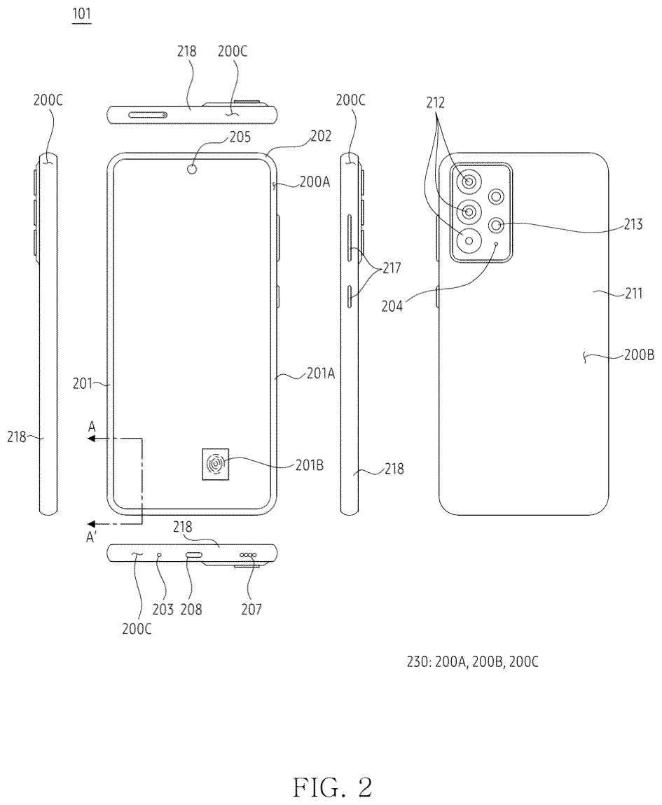

FIG. 2 illustrates an electronic device according to an embodiment.

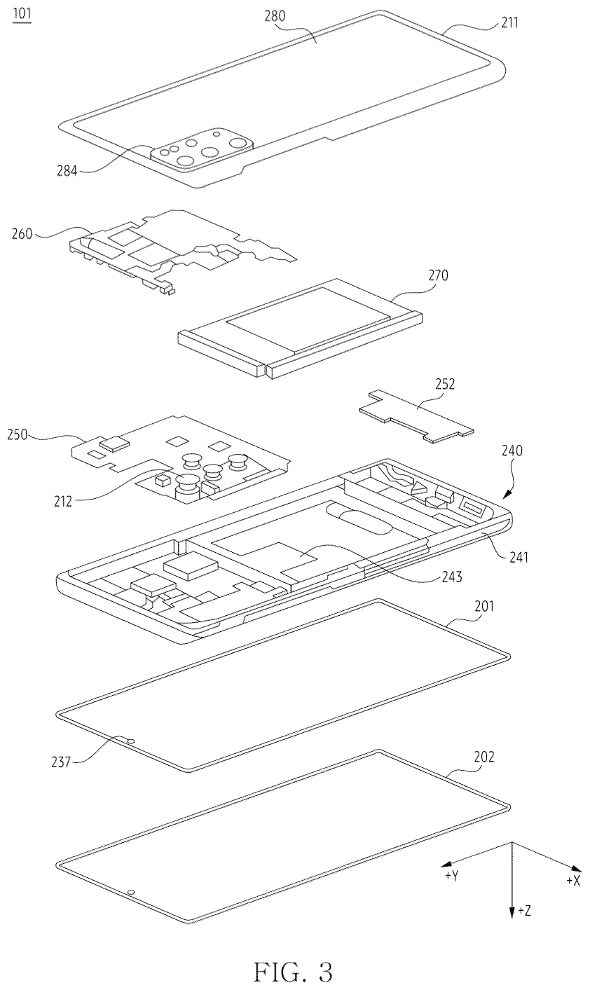

Referring to FIG. 2, the electronic device 101 according to an embodiment may include a housing 230 forming an exterior of the electronic device 101. For example, the housing 230 may include a first surface (or a front surface) 200A, a second surface (or a rear surface) 200B, and a third surface (or a lateral surface) 200C surrounding a space (e.g., an area) between the first surface 200A and the second surface 200B. In an embodiment, the housing 230 may refer to a structure (e.g., a frame structure 240 of FIG. 3) forming at least a portion of the first surface 200A, the second surface 200B, and/or the third surface 200C.

The electronic device 101 according to an embodiment may include a substantially transparent front plate 202. In an embodiment, the front plate 202 may form at least a portion of the first surface 200A. In an embodiment, for example, the front plate 202 may include a glass plate or a polymer plate, including various coating layers, but is not limited to thereto.

The electronic device 101 according to an embodiment may include a substantially opaque rear plate 211. In an embodiment, the rear plate 211 may form at least a portion of the second surface 200B. In an embodiment, the rear plate 211 may be formed of coated or colored glass, ceramic, a polymer, a metal (e.g., aluminum, stainless steel (STS), or magnesium), or a combination of at least two of the above materials.

The electronic device 101 according to an embodiment may include a lateral surface bezel structure (or a lateral surface member) 218 (e.g., a side wall 241 of a frame structure 240 of FIG. 3). In an embodiment, the lateral surface bezel structure 218 may be coupled to the front plate 202 and/or the rear plate 211 to form at least a portion of the third surface 200C of the electronic device 101. For example, the lateral surface bezel structure 218 may form the entire third surface 200C of the electronic device 101, and for another example, the lateral surface bezel structure 218 may form the third surface 200C of the electronic device 101 together with the front plate 202 and/or the rear plate 211.

Unlike the illustrated embodiment, in a case that the third surface 200C of the electronic device 101 is partially formed by the front plate 202 and/or the rear plate 211, the front plate 202 and/or the rear plate 211 may include a region that is seamlessly extended by being bent toward the rear plate 211 and/or the front plate 202 at its periphery. For example, the extended region of the front plate 202 and/or the rear plate 211 may be positioned at both ends of a long edge of the electronic device 101 but is not limited by the above-described example.

In an embodiment, the lateral surface bezel structure 218 may include a metal and/or a polymer. In an embodiment, the rear plate 211 and the lateral surface bezel structure 218 may be integrally formed, and may include the same material (e.g., a metal material such as aluminum), but are not limited thereto. For example, the rear plate 211 and the lateral surface bezel structure 218 may be formed in a separate configuration and/or may include a different material.

In an embodiment, the electronic device 101 may include at least one of a display 201, an audio module 203, 204, and 207, a sensor module, a camera module 205, 212, and 213, a key input device 217, a light emitting element, and/or a connector hole 208. In another embodiment, the electronic device 101 may omit at least one of the components (e.g., the key input device 217 or the light emitting element), or may additionally include another component.

In an embodiment, the display 201 (e.g., the display module 160 of FIG. 1) may be visually exposed through a large portion of the front plate 202. For example, at least a portion of the display 201 may be visible through the front plate 202 forming the first surface 200A. In an embodiment, the display 201 may be disposed on a back surface of the front plate 202.

In an embodiment, an outer shape of the display 201 may be formed generally the same as an outer shape of the front plate 202 adjacent to the display 201. In an embodiment, in order to expand an area in which the display 201 is visually exposed, a distance between an outer periphery of the display 201 and an outer periphery of the front plate 202 may be formed generally the same.

In an embodiment, the display 201 (or the first surface 200A of the electronic device 101) may include a screen display region 201A. In an embodiment, the display 201 may provide visual information to a user through the screen display region 201A. In the illustrated embodiment, when the first surface 200A is viewed frontally, the screen display region 201A is illustrated to be spaced apart from an outer periphery of the first surface 200A and positioned inside the first surface 200A, but is not limited thereto. In another embodiment, when the first surface 200A is viewed frontally, at least a portion of a periphery of the screen display region 201A may also substantially coincide with a periphery of the first surface 200A (or the front plate 202).

In an embodiment, the screen display region 201A may include a sensing region 201B configured to obtain biometric information of the user. Herein, the meaning of “the screen display region 201A includes the sensing region 201B” may be understood as that at least a portion of the sensing region 201B may be overlapped with the screen display region 201A. For example, the sensing region 201B, like another region of the screen display region 201A, may mean a region capable of displaying the visual information by the display 201 and additionally obtaining the biometric information (e.g., fingerprint) of the user. In another embodiment, the sensing region 201B may be formed in the key input device 217.

In an embodiment, the display 201 may include a region in which a first camera module 205 (e.g., the camera module 180 of FIG. 1) is positioned. In an embodiment, an opening is formed in the region of the display 201, and the first camera module 205 (e.g., a punch hole camera) may be at least partially disposed in the opening to face the first surface 200A. In this case, the screen display region 201A may surround at least a portion of a periphery of the opening. In another embodiment, the first camera module 205 (e.g., an under display camera (UDC)) may be disposed under the display 201 to overlap with the region of the display 201. In this case, the display 201 may provide the visual information to the user through the region, and additionally, the first camera module 205 may obtain an image corresponded to a direction toward the first surface 200A through the region of the display 201.

In an embodiment, the display 201 may be combined with or disposed adjacent to a touch sensing circuit, a pressure sensor capable of measuring a strength (pressure) of a touch, and/or a digitizer that detects a magnetic field-type stylus pen.

In an embodiment, the audio module 203, 204, and 207 (e.g., the audio module 170 of FIG. 1) may include a first microphone hole 203, a second microphone hole 204 and a speaker hole 207.

In an embodiment, the first microphone hole 203 is formed in a partial region of the third surface 200C and the second microphone hole 204 is formed in a partial region of the second surface 200B. A microphone for obtaining an external sound may be disposed inside the microphone holes 203 and 204. The microphone may include a plurality of microphone to detect a direction of a sound.

In an embodiment, the second microphone hole 204 formed in the partial region of the second surface 200B may be disposed to be adjacent to the camera module 205, 212, and 213. For example, the second microphone hole 204 may obtain a sound according to an operation of the camera module 205, 212, and 213. However, it is not limited thereto.

In an embodiment, the speaker hole 207 may include an external speaker hole 207 and a receiver hole for a call. The external speaker hole 207 may be formed on a portion of the third surface 200C of the electronic device 101. In another embodiment, the external speaker hole 207 may be implemented as a hole with the microphone hole 203. In an embodiment, the receiver hole for a call may be formed on another portion of the third surface 200C. For example, the receiver hole for a call may be formed on an opposite side of the external speaker hole 207 on the third surface 200C. For example, based on illustration of FIG. 2, the external speaker hole 207 may be formed on the third surface 200C corresponding to a lower end of the electronic device 101, and the receiver hole for a call may be formed on the third surface 200C corresponding to an upper end of the electronic device 101. However, it is not limited thereto, and in another embodiment, the receiver hole for a call may also be formed at a position other than the third surface 200C. For example, the receiver hole for a call may be formed by a separated space between the front plate 202 (or the display 201) and the lateral surface bezel structure 218.

In an embodiment, the electronic device 101 may include at least one speaker configured to output the sound to the outside of the housing through the external speaker hole 207 and/or the receiver hole for a call.

In an embodiment, the sensor module (e.g., the sensor module 176 of FIG. 1) may generate an electrical signal or a data value corresponding to an internal operating state or an external environmental state of the electronic device 101. For example, the sensor module may include at least one of a proximity sensor, a HRM sensor, a fingerprint sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

In an embodiment, the camera module 205, 212, and 213 (e.g., the camera module 180 of FIG. 1) may include a first camera module 205 disposed to face the first surface 200A of the electronic device 101, and a second camera module 212 disposed to face the second surface 200B of the electronic device 101.

In an embodiment, the second camera module 212 may include a plurality of cameras (e.g., a dual camera, a triple camera, or a quad camera). However, the second camera module 212 is not necessarily limited to including the plurality of cameras, and may include a camera.

In an embodiment, the first camera module 205 and the second camera module 212 may include one or a plurality of lenses, an image sensor, and/or an image signal processor.

For example, in an embodiment, a flash 213 may include a light emitting diode or a xenon lamp. In another embodiment, two or more lenses (an infrared camera, wide-angle and telephoto lens) and image sensors may be disposed on a surface of the electronic device 101.

In an embodiment, the key input device 217 (e.g., the input module 150 of FIG. 1) may be disposed on the third surface 200C of the electronic device 101. In another embodiment, the electronic device 101 may not include a portion or all of the key input device 217, and the key input device 217 that is not included may be implemented in another form such as a soft key on the display 201.

In an embodiment, the connector hole 208 may be formed on the third surface 200C of the electronic device 101 so that a connector of the external device may be accommodated. A connection terminal (e.g., the connecting terminal 178 of FIG. 1) electrically connected to the connector of the external device may be disposed in the connector hole 208. The electronic device 101 according to an embodiment may include an interface module (e.g., the interface 177 of FIG. 1) for processing an electrical signal transmitted and received through the connection terminal.

In an embodiment, the electronic device 101 may include the light emitting element. For example, the light emitting element may be disposed on the first surface 200A of the housing 230. The light emitting element may provide state information of the electronic device 101 in an optical form. In another embodiment, the light emitting element may provide a light source linked with an operation of the first camera module 205. For example, the light emitting element may include an LED, an IR LED, and/or the xenon lamp.

FIG. 3 is an exploded perspective view of an electronic device according to an embodiment.

Hereinafter, an overlapping description with respect to a configuration having the same reference code as the above-described configuration will be omitted.

Referring to FIG. 3, an electronic device 101 according to an embodiment may include a frame structure 240, a first PCB 250, a second PCB 252, a cover plate 260, and a battery 270.

In an embodiment, the frame structure 240 may include a side wall 241 forming an exterior (e.g., the third surface 200C of FIG. 2) of the electronic device 101 and a support portion 243 extended inside from the side wall 241. In an embodiment, the frame structure 240 may be disposed between a display 201 and a rear plate 211. In an embodiment, the side wall 241 of the frame structure 240 may surround a space between the rear plate 211 and a front plate 202 (and/or the display 201), and the support portion 243 of the frame structure 240 may be extended from the side wall 241 in the space.

In an embodiment, the frame structure 240 may support or accommodate other components included in the electronic device 101. For example, the display 201 may be disposed on a surface of the frame structure 240 facing in a direction (e.g., +z direction), and the display 201 may be supported by the support portion 243 of the frame structure 240. For another example, the first PCB 250, the second PCB 252, the battery 270, and a second camera module 212 may be disposed on another surface facing a direction (e.g., −z direction) opposite to the direction of the frame structure 240. The first PCB 250, the second PCB 252, the battery 270, and the second camera module 212 may be seated in a recess, respectively, defined by the side wall 241 and/or the support portion 243 of the frame structure 240.

In an embodiment, the first PCB 250, the second PCB 252, and the battery 270 may be coupled to the frame structure 240, respectively. For example, the first PCB 250 and the second PCB 252 may be fixedly disposed at the frame structure 240 through a coupling member such as a screw. For example, the battery 270 may be fixedly disposed at the frame structure 240 through an adhesive (e.g., a double-sided tape). However, it is not limited by the above-described example.

In an embodiment, the cover plate 260 may be disposed between the first PCB 250 and the rear plate 211. In an embodiment, the cover plate 260 may be disposed on the first PCB 250. For example, the cover plate 260 may be disposed on a surface of the first PCB 250 facing the −z direction.

In an embodiment, the cover plate 260 may at least partially overlap the first PCB 250 based on a z-axis. In an embodiment, the cover plate 260 may cover at least a portion of the first PCB 250. Through this, the cover plate 260 may protect the first PCB 250 from a physical impact or prevent a connector (e.g., a connector 34 of FIG. 3) coupled to the first PCB 250 from being separated.

In an embodiment, the cover plate 260 may be fixedly disposed at the first PCB 250 through the coupling member (e.g., the screw), or may be coupled to the frame structure 240 together with the first PCB 250 through the coupling member.

In an embodiment, the display 201 may be disposed between the frame structure 240 and the front plate 202. For example, the front plate 202 may be disposed on a side (e.g., +z direction) of the display 201, and the frame structure 240 may be disposed on another side (e.g., −z direction).

In an embodiment, the front plate 202 may be coupled to the display 201. For example, the front plate 202 and the display 201 may be adhered to each other through an optical adhesive (e.g., optically clear adhesive (OCA) or optically clear resin (OCR)) interposed between them.

In an embodiment, the front plate 202 may be coupled to the frame structure 240. For example, the front plate 202 may include an outer portion extended outside the display 201 when viewed in the z-axis direction, and may be adhered to the frame structure 240 through the adhesive (e.g., the double-sided tape) disposed between the outer portion of the front plate 202 and the frame structure 240 (e.g., the side wall 241). However, it is not limited by the above-described example.

In an embodiment, the first PCB 250 and/or the second PCB 252 may be equipped with a processor (e.g., the processor 120 of FIG. 2), memory (e.g., the memory 130 of FIG. 2), and/or an interface (e.g., the interface 177 of FIG. 2). For example, the processor may include one or more of a central processing unit, an application processor, a graphics processing unit, an image signal processor, a sensor hub processor, or a communication processor. For example, the memory may include a volatile memory or a nonvolatile memory. For example, the interface may include a high definition multimedia interface (HDMI), a universal serial bus (USB) interface, an SD card interface, and/or an audio interface. The interface may electrically or physically connect the electronic device 101 to an external electronic device, and may include a USB connector, an SD card/a multimedia card (MMC) connector, or an audio connector. In an embodiment, the first PCB 250 and the second PCB 252 may be operatively or electrically connected to each other through a connecting member (e.g., a flexible PCB).

In an embodiment, the battery 270 (e.g., the battery 189 of FIG. 2) may supply power to at least one component of the electronic device 101. For example, the battery 270 may include a rechargeable secondary battery or a fuel cell. At least a portion of the battery 270 may be disposed substantially on the same plane with the first PCB 250 and/or the second PCB 252.

The electronic device 101 according to an embodiment may include an antenna module (e.g., the antenna module 197 of FIG. 2). In an embodiment, the antenna module may be disposed between the rear plate 211 and the battery 270. For example, the antenna module may include a near field communication (NFC) antenna, a wireless charging antenna, and/or a magnetic secure transmission (MST) antenna. For example, the antenna module may perform short-range communication with an external device or wirelessly transmit and receive the power with the external device.

In an embodiment, a first camera module 205 (e.g., a front camera) may be disposed at least a portion (e.g., the support portion 243) of the frame structure 240 so that a lens may receive external light through a partial region (e.g., a camera region 237) of the front plate 202 (e.g., the front surface 200A of FIG. 2).

In an embodiment, the second camera module 212 (e.g., a rear camera) may be disposed between the frame structure 240 and the rear plate 211. In an embodiment, the second camera module 212 may be electrically connected to the first PCB 250 through a connecting member (e.g., a connector). In an embodiment, the second camera module 212 may be disposed so that a lens may receive external light through a camera region 284 of the rear plate 211 of the electronic device 101.

In an embodiment, the camera region 284 may be formed on an outer surface (e.g., the rear surface 200B of FIG. 2) of the rear plate 211. In an embodiment, the camera region 284 may be at least partially transparently formed so that the external light may be incident on the lens of the second camera module 212. In an embodiment, at least a portion of the camera region 284 may protrude from the outer surface of the rear plate 211 to a predetermined height. However, it is not limited thereto, and in another embodiment, the camera region 284 may form substantially the same plane as the outer surface of the rear plate 211.

In an embodiment, a housing 230 of the electronic device 101 may mean a configuration or a structure forming at least a portion of the exterior of the electronic device 101. In this respect, at least a portion of the front plate 202, the frame structure 240, and/or the rear plate 211 forming the exterior of the electronic device 101 may be referred to as the housing 230 of the electronic device 101.

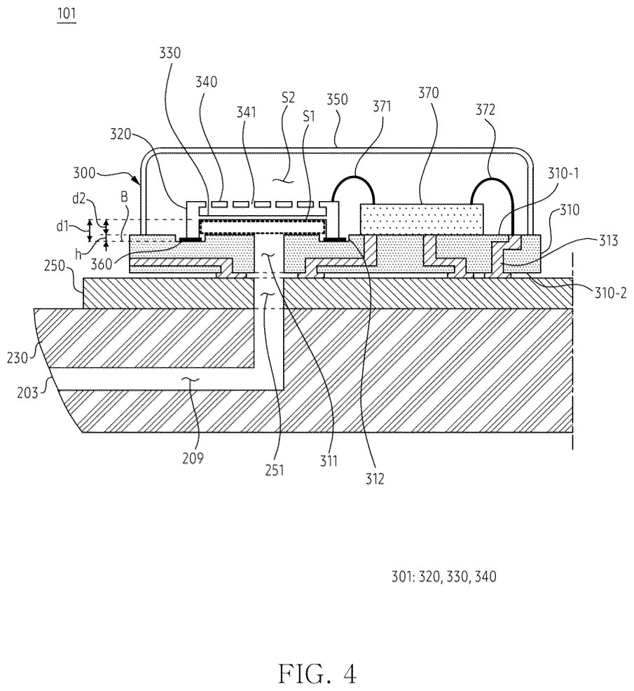

FIG. 4 is a cross-sectional view of an example electronic device cut along line A-A′ of FIG. 2.

Referring to FIG. 4, an electronic device 101 according to an embodiment may include a housing 230 and an audio input device 300.

According to an embodiment, the housing 230 may be or correspond to an exterior of the electronic device 101. The housing 230 may be referred to as the housing 230 of FIG. 2. According to an embodiment, the housing 230 may include a microphone hole 203 and a duct 209. For example, the microphone hole 203 may be formed on a lateral surface of the housing 230 (e.g., the third surface 200C of FIG. 2). The microphone hole 203 may spatially connect the outside of the housing 230 and the inside of the housing 230 so that sound waves may be introduced into the inside of the housing 230 from the outside of the housing 230. The duct 209 may provide a path through which the sound waves introduced into the microphone hole 203 are transmitted to the audio input device 300. The sound waves introduced into the microphone hole 203 may move to the audio input device 300 through a vibration of air in the duct 209.

According to an embodiment, a PCB 250 may provide an electrical connection between components of the electronic device 101. The PCB 250 may include a plurality of conductive layers and a plurality of non-conductive layers alternately laminated with the plurality of conductive layers. For example, the PCB 250 may provide the electrical connection between the PCB 250 and/or various electronic components disposed outside the PCB 250, using wirings and conductive vias formed on the conductive layer.

According to an embodiment, the audio input device 300 may convert an analog signal (e.g., sound waves) received from the outside of the housing 230 into an electrical signal. For example, the audio input device 300 may include a microphone. The audio input device 300 may be disposed in the housing 230. According to an embodiment, the audio input device 300 may include a substrate 310, micro electro mechanical systems (MEMS) 301, and/or a plate 340. For example, the MEMS 301 may be an element capable of converting the analog signal into the electrical signal. In an embodiment, the MEMS 301 may include a side wall 320, a diaphragm 330, and/or a plate 340.

According to an embodiment, the substrate 310 may provide the electrical connection between components of the audio input device 300 and/or the electrical connection between the audio input device 300 and another component of the electronic device 101. For example, the substrate 310 may be disposed on the PCB 250, and the substrate 310 may be electrically connected to the PCB 250. For example, an audio signal generated from the audio input device 300 may be transmitted to the PCB 250 through conductive layers 313 in the substrate 310.

According to an embodiment, the substrate 310 may include a through hole 311 penetrating from a surface 310-1 to another surface 310-2 opposite to the surface 310-1. For example, the PCB 250 may include a first opening 251 disposed in a position corresponding to the through hole 311 and connected to the duct 209. Sound waves outside the electronic device 101 may be transmitted to the duct 209 through the microphone hole 203. The sound waves may be transmitted to the first opening 251 along the duct 209. The sound waves may be transmitted to the diaphragm 330 after passing through the first opening 251 and the through hole 311. For example, sound waves generated by a user's voice may be introduced into the duct 209 through the microphone hole 203. The sound waves may be transmitted to the first opening 251 using air in the duct 209 as a medium. The sound waves may pass through the first opening 251 and the through hole 311, and then be transmitted to the diaphragm 330. According to an embodiment, the audio input device 300 may be referred to as a bottom port type, including an inlet through which the sound waves are introduced into the audio input device 300 on the substrate 310.

According to an embodiment, the diaphragm 330 may be supported by the side wall 320. The diaphragm 330 may be spaced apart from the surface 310-1 in a direction where the surface 310-1 faces. According to an embodiment, the plate 340 may be supported by the side wall 320. For example, the plate 340 may be referred to as a back plate. The plate 340 may be spaced apart from the diaphragm 330 in the direction where the surface 310-1 faces. The plate 340 may include a plurality of holes 341 through which air between the diaphragm 330 and the plate 340 may flow.

The electronic device 101 according to an embodiment may include a processor (e.g., the processor 120 of FIG. 1) operatively connected to the audio input device 300. The processor may be configured to obtain an audio signal from the audio input device 300. According to an embodiment, the diaphragm 330 may vibrate by sound waves. As the diaphragm 330 vibrates, a distance between the diaphragm 330 and the plate 340 may change. The change in the distance between the diaphragm 330 and the plate 340 may cause a change in capacitance. For example, the plate 340 may include a first electrode disposed on a surface facing the diaphragm 330. The diaphragm 330 may include a second electrode disposed on a surface facing the plate 340. The sound waves introduced through the through hole 311 may vibrate the diaphragm 330. When the diaphragm 330 vibrates, a gap between the first electrode and the second electrode may change. Due to the change in a distance between the first electrode and the second electrode, the capacitance between the first electrode and the second electrode may change. For example, the processor may be configured to obtain an audio signal generated based on the change in the capacitance.

According to an embodiment, the audio input device 300 may include signal processing circuitry 370 configured to generate the audio signal, based on the change in the capacitance. For example, the signal processing circuitry 370 may include a detection circuit for detecting the change in the capacitance and an amplifier for amplifying the detected signal. For example, the signal processing circuitry 370 may include an application-specific integrated circuit (ASIC), but is not limited thereto. The signal processing circuitry 370 may be disposed on the substrate 310. The signal processing circuitry 370 may be configured to generate the audio signal, which is the electrical signal, based on the change in the capacitance between the diaphragm 330 and the plate 340. For example, the signal processing circuitry 370 may be configured to detect the change in the capacitance caused by the change in the distance between the diaphragm 330 and the plate 340. The signal processing circuitry 370 may be configured to generate the audio signal, which is the electrical signal, based on the detected change in the capacitance. The signal processing circuitry 370 may be configured to transmit the generated audio signal to the processor through the PCB 250. The processor may transmit the audio signal obtained from the signal processing circuitry 370 to the sound output module (e.g., the sound output module 155 of FIG. 1) through the PCB 250. The sound output module may generate a vibration corresponding to the audio signal. The vibration may be transmitted to the outside of the housing 230 through a speaker hole (e.g., the speaker hole 207 of FIG. 2) formed in the housing 230. The signal processing circuitry 370 may be electrically connected to the diaphragm 330 and/or the plate 340 through a first lead wire 371. The signal processing circuitry 370 may be electrically connected to the substrate 310 through a second lead line 372.

According to an embodiment, the audio input device 300 may include a cover 350. The cover 350 may be disposed on the surface 310-1 of the substrate 310. The cover 350 may be configured to surround the side wall 320, the plate 340, and/or the signal processing circuitry 370. According to an embodiment, the audio input device 300 may include a first space S1 and a second space S2. The first space S1 may be surrounded by the surface 310-1, the side wall 320, and the diaphragm 330 of the substrate 310. In a space surrounded by the cover 350 and the substrate 310, the second space S2 may be surrounded by a space other than a space occupied by components in the space. For example, the second space S2 may be surrounded by the MEMS 301 including the surface 310-1 of the substrate 310, the cover 350, the side wall 320 and the plate 340. For example, the second space S2 may be surrounded by the MEMS 301 including the surface 310-1 of the substrate 310, the cover 350, the signal processing circuitry 370, and the side wall 320 and the plate 340. The first space S1 may be referred to as a front chamber, which is a space between the through hole 311 through which the sound waves are introduced and the diaphragm 330. The second space S2 may be referred to as a back chamber, which is a space opposite to the space through which the sound waves are introduced, based on the diaphragm 330.

According to an embodiment, a resonant frequency of the audio input device 300 may be adjusted based on a volume of a space surrounded by the surface 310-1 of the substrate 310, the side wall 320, and the diaphragm 330. The space may be referred to as the first space S1. The sound waves introduced into the first space S1 through the through hole 311 may form Helmholtz resonant, by interacting with air in the first space S1. In a case that the volume of the first space S1 is large, since there is a lot of air in the first space S1, the resonant frequency of the audio input device 300 may get lower. In a case that the volume of the first space S1 is small, since the air in the first space S1 is small, the resonant frequency of the audio input device 300 may get higher. In a case that the resonant frequency of the audio input device 300 is high, frequency response characteristic may be improved, and thus the frequency response may become flat. In a case that the resonant frequency is low, a frequency band to be used may get higher than the resonant frequency, and the frequency response characteristic of the audio input device 300 may deteriorate.

According to an embodiment, sensitivity of the audio input device 300 may be adjusted based on the volume of the second space S2 referred to as the back chamber. In a case that the volume of the second space S2 is large, since there is a lot of air in the second space S2, the diaphragm 330 may be easily vibrated based on the sound waves. As sensitivity of the diaphragm 330 is improved, the sensitivity of the audio input device 300 may be improved, and a signal to noise ratio (SNR) of the audio input device 300 may get higher. In a case that the volume of the second space S2 is small, since there is little air in the second space S2, it may be difficult for the diaphragm 330 to vibrate. Since the vibration of the diaphragm 330 becomes difficult, the sensitivity of the audio input device 300 may deteriorate, and the SNR of the audio input device 300 may get lower.

According to an embodiment, as a size of the diaphragm 330 is increased, noise of the audio input device 300 may be reduced. In order to reduce the noise, in a case that the size of the diaphragm 330 is increased, a volume of the front chamber may be increased and a volume of the back chamber may be decreased. As the volume of the front chamber is increased, the frequency response characteristic of the audio input device 300 may deteriorate. As the volume of the back chamber is decreased, the sensitivity of the audio input device 300 may be decreased. For example, the sensitivity of the audio input device 300 may get lower in an arbitrary frequency range.

According to an embodiment, the substrate 310 may include a seating groove 312 so that the volume of the first space S1 is decreased and the volume of the second space S2 is increased. The seating groove 312 may be dented from the surface 310-1 toward another surface 310-2 opposite to the surface 310-1. The side wall 320 may be disposed on the seating groove 312. For example, a portion of the side wall 320 may be inserted into the seating groove 312. As the side wall 320 is disposed on the seating groove 312, a distance d2 between the diaphragm 330 and the surface 310-1 may be reduced by a height h of the seating groove 312 from a distance d1 between the diaphragm 330 and a bottom surface B of the side wall 320. The height h of the seating groove 312 may be a distance from the bottom surface B of the seating groove 312 to the surface 310-2. As the distance d2 is decreased, the volume of the first space S1 may be decreased, and the volume of the second space S2 may be increased. According to an embodiment, the frequency response characteristic and the sensitivity of the audio input device 300 may be improved.

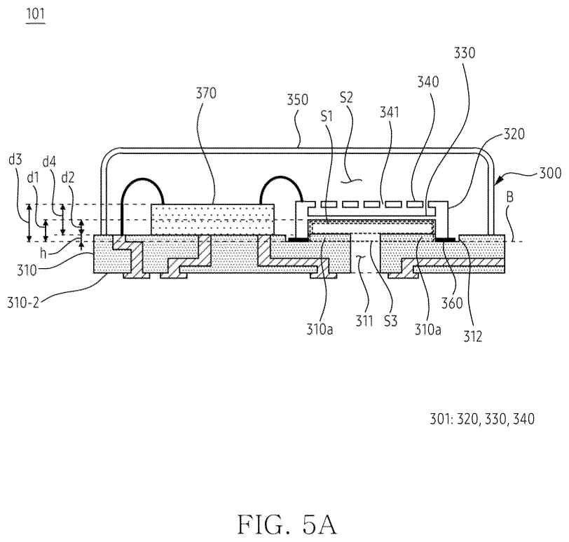

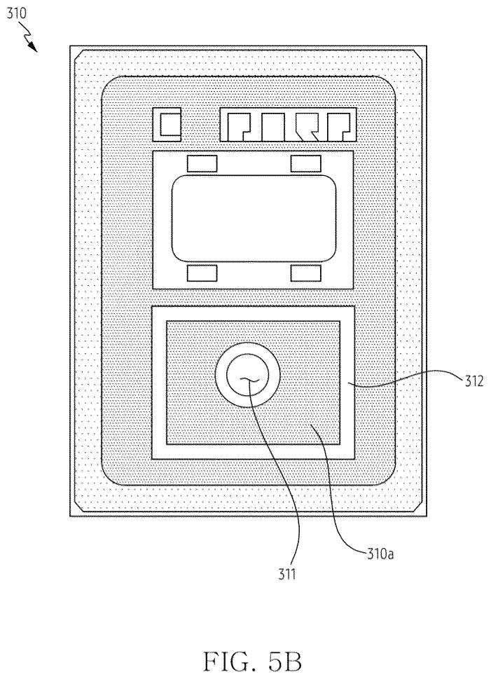

FIG. 5A illustrates an example audio input device. FIG. 5B is a plan view of an example substrate of an audio input device.

Referring to FIGS. 5A and 5B, a side wall 320 may be disposed on a seating groove 312 formed on a surface 310-1 of a substrate 310. The seating groove 312 may be dented from the surface 310-1 of the substrate 310 toward another surface 310-2 opposite to the surface 310-1. A height h of the seating groove 312 may be a distance from a bottom surface B of the seating groove 312 to the surface 310-1. As the side wall 320 is disposed on the seating groove 312, a portion of the side wall 320 may be inserted into the seating groove 312.

According to an embodiment, the seating groove 312 may be spaced apart from a periphery of a through hole 311. Since the seating groove 312 does not extend from the through hole 311 and is spaced apart from the periphery of the through hole 311, a portion 310a of the substrate 310 disposed between the seating groove 312 and the through hole 311 may occupy a portion of a space surrounded by a diaphragm 330 and the side wall 320. The portion 310a of the substrate 310 may protrude from the bottom surface B of the side wall 320 toward the diaphragm. A volume occupied by the portion 310a of the substrate 310 may be adjusted according to a size of the diaphragm 330 and the height h of the seating groove 312. According to an embodiment, the seating groove 312 may surround the through hole 311. For example, the seating groove 312 may be formed to correspond to a shape of the side wall 320. The side wall 320 may surround the through hole 311 by being inserted into the seating groove 312. The through hole 311 may be spatially connected to a first space S1 surrounded by the surface 310-1, the side wall 320, and the diaphragm 330.

According to an embodiment, as the size of the diaphragm 330 is increased, noise of the audio input device 300 may be reduced. As the size of the diaphragm 330 is increased, a volume of the first space S1 may also be increased. In a case that the volume of the first space S1 is increased, frequency response characteristic of the audio input device 300 may be deteriorated.

According to an embodiment, the volume of the first space S1 surrounded by the surface 310-1 of the substrate 310, the side wall 320, and the diaphragm 330 may be smaller than a volume of a third space S3 surrounded by the bottom surface B of the side wall 320, the side wall 320, and the diaphragm 330, in accordance with the side wall 320 disposed on the seating groove 312.

For example, in the case of an audio input device that does not include the seating groove, the side wall may be in direct contact with a surface. In the audio input device of the structure, the third space S3 may be referred to as a front chamber of the audio input device. A height of the third space S3 may be a first distance d1 that is a distance from the bottom surface B of the side wall to the diaphragm.

According to an embodiment, in a case that the side wall 320 is disposed on the seating groove 312, the first space S1 may be referred to as a front chamber. Compared to the audio input device in which the side wall is disposed on the surface of the substrate, a height of the first space S1 referred to as the front chamber according to an embodiment may be reduced by the height h of the seating groove 312. According to an embodiment, the height of the first space S1 may be a second distance d2, which is a distance from the surface 310-1 of the substrate 310 to the diaphragm 330. Since the second distance d2 is a distance excluding the height h of the seating groove 312 from the first distance d1, the second distance d2 may be shorter than the first distance d1. According to an embodiment, as the height of the first space S1 is reduced from the height of the third space S3, the volume of the first space S1 may be reduced from the volume of the third space S3. The volume of the first space S1 may be decreased by a difference between the first distance d1 and the second distance d2. As the volume of the first space S1 referred to as the front chamber decreases, a resonant frequency of the audio input device 300 may get higher. The frequency response characteristic of the audio input device 300 according to an embodiment may be improved.

For example, in a case that the side wall is in direct contact with the surface of the substrate, and the first distance d1 is 0.5 mm, a length of the diaphragm is 1.0 mm, and a width of the diaphragm is 1.0 mm, the volume of the third space S3 surrounded by the surface, the side wall, and the diaphragm may be 0.5 mm³. The third space S3 may be referred to as the front chamber. In order to reduce noise, in a case that the length of the diaphragm is increased to 2.0 mm and the width of the diaphragm is increased to 2.0 mm, the volume of the third space S3 may be 2.0 mm³. In a case that the side wall is in contact with the surface of the substrate, the volume of the third space S3 may be increased by four times as the length and the width of the diaphragm are doubled. As the volume of the third space S3 which is the front chamber is increased by four times, the resonant frequency of the audio input device may be reduced. Since the resonant frequency of the audio input device is reduced, the frequency response characteristic of the audio input device may be deteriorated.

According to an embodiment, in a case that the size of the diaphragm 330 is increased, the seating groove 312 having a height of 0.25 mm is formed on the surface 310-1, and the side wall 320 is disposed on the seating groove 312, the height of the first space S1 may be 0.25 mm. The volume of the first space S1 may be 1.0 mm³. According to an embodiment, even if the length and the width of the diaphragm 330 are doubled, the volume of the first space S1 may be doubled. Since the side wall 320 is disposed on the seating groove 312, the volume of the first space S1 may be reduced from the volume of the third space S3. As the volume of the first space S1, which is the front chamber, is doubled, deterioration of the frequency response characteristic of the audio input device 300 may be decreased. According to an embodiment, since the volume of the front chamber may be reduced, the frequency response characteristic of the audio input device 300 may be improved.

According to an embodiment, a volume of the second space S2, which is a space excluding a component (e.g., the MEMS 301 and/or the signal processing circuitry 370) occupying a portion of the space in the space surrounded by the cover 350 and the substrate 310, may be increased in accordance with the side wall 320 disposed on the seating groove 312. For example, the volume of the second space S2 may be a volume excluding a volume in which the MEMS 301 occupies the space and/or a volume in which the signal processing circuitry 370 occupies the space, from a volume of the space surrounded by the cover 350 and the substrate 310.

For example, in the case of an audio input device that does not include the seating groove, the side wall may be in direct contact with the surface. In the audio input device of the structure, the height of a space occupied by the side wall and the plate may be a third distance d3, which is a distance from the bottom surface B of the side wall to the plate.

According to an embodiment, in a case that the side wall 320 is disposed on the seating groove 312, a height of a space occupied by the side wall 320 and the plate 340 may be a fourth distance d4, which is a distance from the surface 310-1 of the substrate 310 to the plate 340. Since the fourth distance d4 may be a distance excluding the height h of the seating groove 312 from the third distance d3, the fourth distance d4 may be shorter than the third distance d3. According to an embodiment, as the height of the space occupied by the side wall 320 and the plate 340 is reduced, the volume of the second space S2 may be increased. For example, the volume of the second space S2 may be increased by a difference between the third distance d3 and the fourth distance d4. In a case that the volume of the second space S2 referred to as the back chamber is increased, sensitivity of the audio input device 300 may be improved, and a SNR of the audio input device 300 may get higher.

The electronic device 101 according to an embodiment may further include an adhesive 360 disposed between the seating groove 312 and the side wall 320. The adhesive 360 may attach the side wall 320 on the seating groove 312. The adhesive 360 may be applied to the seating groove 312. In a state in which the adhesive 360 is applied to the seating groove 312, the side wall 320 may be inserted into the seating groove 312. The side wall 320 may be fixed on the seating groove 312 through the adhesive 360.

According to an embodiment, the height h of the seating groove 312 may be adjusted based on the size of the diaphragm 330 in order to maintain the volume of the first space S1 constantly. The resonant frequency of the audio input device 300 may be adjusted based on the volume of the first space S1 referred to as the front chamber. The volume of the first space S1 may be different according to the structure of the audio input device 300 disposed in the electronic device 101. For example, in a case that the audio input device 300 having a different structure each other is disposed in a housing (e.g., the housing 230 of FIG. 4) of the same structure, the resonant frequency of the audio input device 300 may be different. As the resonant frequency of the audio input device 300 changes, the audio input device 300 disposed in the housing 230 may have frequency response characteristic different from the designed frequency response characteristic.

According to an embodiment, in a case that the height h of the seating groove 312 is adjusted based on the size of the diaphragm 330, the volume of the first space S1 may be maintained constantly even if a structure of the MEMS 301 of the audio input device 300 is different. For example, in a case that the size of the diaphragm 330 is increased, the volume of the first space S1 may be maintained constantly by increasing the height h of the seating groove 312. For example, in a case that the size of the diaphragm 330 is decreased, the volume of the first space S1 may be maintained constantly by decreasing the height h of the seating groove 312. According to an embodiment, even if the structure of the audio input device 300 disposed in the housing 230 is different, the volume of the first space S1 may be maintained constantly. According to an embodiment, since the volume of the front chamber may be maintained constantly, the electronic device 101 may have substantially the same frequency response characteristic as the designed frequency response characteristic.

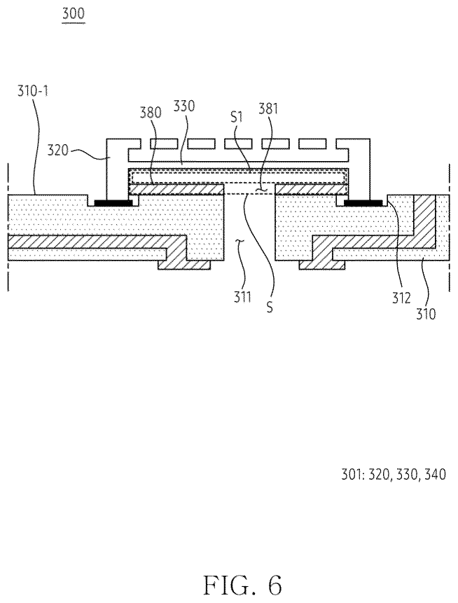

FIG. 6 illustrates an example audio input device.

Referring to FIG. 6, an audio input device 300 may further include a support 380 disposed in MEMS 301. The support 380 may occupy a portion of a space S surrounded by a surface 310-1 of a substrate 310, a side wall 320, and a diaphragm 330. For example, the support 380 may face the diaphragm 330, by being disposed on the surface 310-1 of the substrate 310. The diaphragm 330 may be spaced apart from the support 380. Since the diaphragm 330 is disposed in the space S, it may occupy the portion of the space S. According to an embodiment, the support 380 may include a second opening 381 disposed at a position corresponding to a through hole 311. Sound waves transmitted through the through hole 311 may be transmitted into the space S by passing through the second opening 381. According to an embodiment, the support 380 may be integrated with the side wall 320. For example, the support 380 may extend from the side wall 320 toward the through hole 311.

According to an embodiment, a volume of a front chamber adjusting a resonant frequency of the audio input device 300 may be reduced by a volume of the support 380. The front chamber of the audio input device that does not include the support may be referred to as the space S surrounded by the surface, the side wall, and the diaphragm. According to an embodiment, as the support 380 is disposed, a first space S1 referred to as the front chamber may be surrounded by the surface 310-1 of the substrate 310, the side wall 320, the diaphragm 330, and the support 380. According to an embodiment, the support 380 may reduce a volume of the space S to a volume of the first space S1, by occupying the portion of the space S in the side wall 320. For example, compared to an example including the space S corresponding to the first space S1, as the first space S1 is reduced by the support 380, frequency response characteristic of the audio input device 300 may be improved.

According to an embodiment, the volume of the support 380 may be adjusted based on a size of the diaphragm 330 in order to maintain the volume of the first space S1 constantly. The resonant frequency of the audio input device 300 may be adjusted based on the volume of the first space S1. In order to reduce noise, in a case that the size of the diaphragm 330 is increased, the volume of the space S may be increased. As the volume of the space S is increased, since the resonant frequency of the audio input device 300 gets lower, the frequency response characteristic may be deteriorated. According to an embodiment, the support 380 may maintain the volume of the first space S1 referred to as the front chamber constantly, by occupying the portion of the space S surrounded by the surface 310-1 of the substrate 310, the side wall 320, and the diaphragm 330. For example, in a case that the size of the diaphragm 330 is increased, the volume of the support 380 may also be increased. As the size of the diaphragm 330 is increased, even if the volume of the space S surrounded by the surface 310-1 of the substrate 310, the side wall 320, and the diaphragm 330 is increased, the volume of the first space S1 may be maintained constantly, since the volume of the support 380 may be increased.

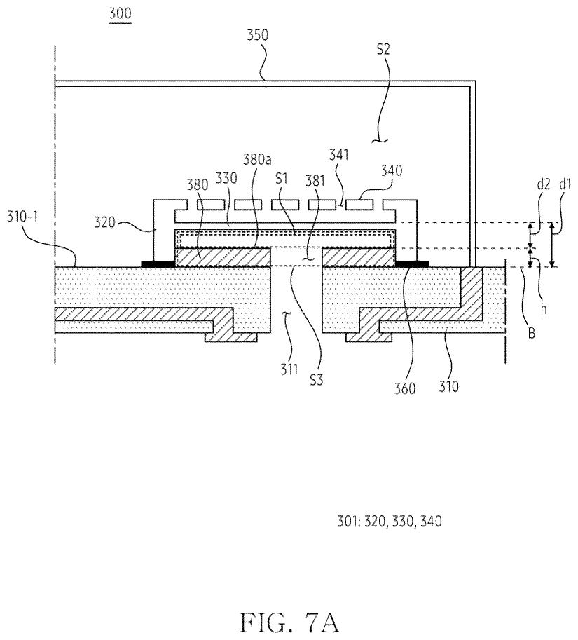

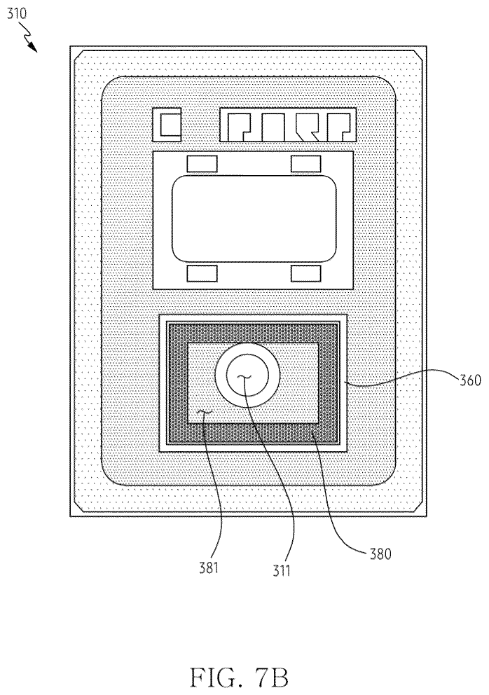

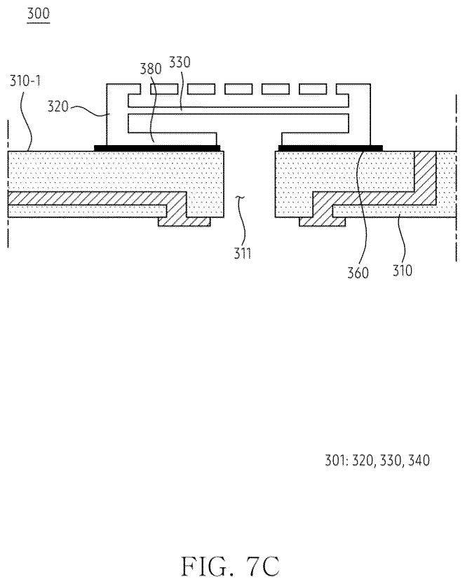

FIG. 7A illustrates an example audio input device including a support. FIG. 7B is a plan view of an example substrate of an audio input device. FIG. 7C illustrates an example audio input device in which a support and a side wall are integrated.

Hereinafter, an audio input device 300 illustrated in FIGS. 7A, 7B, and 7C may be substantially the same as the audio input device 300 described with reference to FIGS. 4, 5A, 5B, and 6 except for descriptions described with reference to FIGS. 7A, 7B, and 7C. The same reference numeral is assigned to the same component, and an overlapping description may be omitted.

Referring to FIG. 7A, the audio input device 300 may include a substrate 310, a support 380, MEMS 301, and/or a cover 350. The MEMS 301 may include a side wall 320, a diaphragm 330, and/or a plate 340.

According to an embodiment, the side wall 320 may be disposed on a surface 310-1 of the substrate 310. The substrate 310 may include a through hole 311 through which sound waves are transmitted. The through hole 311 may be connected to a microphone hole 203 through a duct (e.g., the duct 209 of FIG. 4). The diaphragm 330 may be supported by the side wall 320, and may be spaced apart from the surface 310-1 in a direction where the surface 310-1 faces. The plate 340 may be supported by the side wall 320 and be spaced apart from the diaphragm 330 in the direction. The plate 340 may include a plurality of holes 341 through which air may flow. The cover 350 may be disposed on the surface 310-1. The cover 350 may surround the side wall 320 and the plate 340.

According to an embodiment, the support 380 may be disposed between the through hole 311 and the side wall 320. For example, the support 380 may be surrounded by the side wall 320. Referring to FIG. 7B, the support 380 may surround the through hole 311. The support 380 may be spaced apart from a periphery of the through hole 311. The side wall 320 may be disposed outside the support 380. For example, an adhesive 360 may be applied between the support 380 and the substrate 310. The adhesive 360 may attach the side wall 320 on the substrate 310. The side wall 320 may be fixed on the substrate 310 through the adhesive 360.

According to an embodiment, the support 380 may face the diaphragm 330, and be spaced apart from the diaphragm 330, by being disposed on the surface 310-1. According to an embodiment, the support 380 may occupy a portion of a third space S3 surrounded by the surface 310-1, the side wall 320, and the diaphragm 330. According to an embodiment, the support 380 may include an opening 381 disposed at a position corresponding to the through hole 311. The opening 381 may be connected to the through hole 311. The sound waves transmitted through the through hole 311 may pass through the opening 381 and be transmitted to the diaphragm 330. The diaphragm 330 may be vibrated by the sound waves. An area of the opening 381 may be equal to an area of the through hole 311 or larger than the area of the through hole 311.

Referring to FIG. 7C, the support 380 may be integrated with the side wall 320. For example, the support 380 may extend from the side wall 320 toward the through hole 311. The support 380 may be a portion of the side wall 320 which may support the side wall 320 by being disposed on the surface 310-1 of the substrate 310. In a case that the support 380 is implemented integrally with the side wall 320, the support 380 may be attached to the surface 310-1 of the substrate 310 through the adhesive 360. According to an embodiment, the side wall 320 may be stably fixed on the substrate 310 through the support 380, which is the portion of the side wall 320.

According to an embodiment, the audio input device 300 may include a first space S1 surrounded by the side wall 320, the diaphragm 330, and the support 380, and a second space S2 surrounded by the surface 310-1, the cover 350, the side wall 320, and the plate 340. The first space S1 may be referred to as a front chamber. The second space S2 may be referred to as a back chamber.

According to an embodiment, the audio input device 300 may be referred to as a bottom port type in which an inlet through which sound waves are introduced is formed on the substrate 310. A resonant frequency of the audio input device 300 may be adjusted based on the first space S1. As a size of the diaphragm 330 is increased, the first space S1 may be increased. In a case that the first space S1 is increased, the resonant frequency of the audio input device 300 may get lower. As the resonant frequency of the audio input device 300 gets lower, frequency response characteristic of the audio input device 300 may be deteriorated.

According to an embodiment, a volume of the first space S1 may be reduced from a volume of the third space S3 surrounded by the bottom surface B of the side wall 320, the side wall 320, and the diaphragm 330 in accordance with the support 380 disposed between the through hole 311 and the side wall 320. The support 380 may reduce a volume of the front chamber of the audio input device 300 from the volume of the third space S3 by occupying the portion of the third space S3.

For example, in the case of an audio input device that does not include the support, the third space S3 may be referred to as the front chamber. A height of the third space S3 may be a first distance d1 that is a distance from the bottom surface B of the side wall to the diaphragm.

According to an embodiment, in the case of the audio input device 300 including the support 380 disposed between the through hole 311 and the side wall 320, the first space S1 may be referred to as the front chamber. Compared to the audio input device that does not include the support, a height of the front chamber may be reduced by a height h of the support 380. According to an embodiment, a height of the first space S1 may be a second distance d2, which is a distance from a surface 380a facing the diaphragm 330 of the support 380 to the diaphragm 330. Since the second distance d2 may be a distance excluding the height h of the support 380 from the first distance d1, the second distance d2 may be shorter than the first distance d1. According to an embodiment, as the height of the first space S1 is reduced from the height of the third space S3, the volume of the first space S1 may be reduced from the volume of the third space S3. The volume of the first space S1 may be reduced by a volume in which the support 380 occupies the third space S3. As the volume of the first space S1 referred to as the front chamber is reduced, the resonant frequency of the audio input device 300 may get lower. The frequency response characteristic of the audio input device 300 according to an embodiment may be improved.

For example, in a case that the first distance d1 is 0.5 mm, a length of the diaphragm is 1.0 mm, and a width of the diaphragm is 1.0 mm, the volume of the third space S3 surrounded by the surface, the side wall, and the diaphragm 330 may be 0.5 mm³. In order to reduce noise, in a case that the length of the diaphragm is increased to 2.0 mm and the width of the diaphragm is increased to 2.0 mm, the volume of the third space S3 surrounded by the surface, the side wall, and the diaphragm 330 may be 2.0 mm³. In the case of an audio input device having the structure, the third space S3 may be referred to as the front chamber. In the case of an audio input device that does not include the support, as the size of the diaphragm is increased, the volume of the third space S3 surrounded by a volume of a space surrounded by the side wall and the diaphragm may be increased four times. As the volume of the third space S3 which is the front chamber is increased by four times, the frequency response characteristic of the audio input device may be deteriorated.

According to an embodiment, in a case that the first distance is 0.5 mm, the length of the diaphragm 330 is 2.0 mm, and the width of the diaphragm is 2.0 mm, the height of the first space S1 may be 0.25 mm, which is the second distance d2, as the support 380 having a height of 0.25 mm is disposed between the through hole 311 and the side wall 320. The volume of the first space S1 may be 1.0 mm³. According to an embodiment, even if the length and the width of the diaphragm 330 are doubled, the volume of the first space S1 may be doubled. Since the support 380 is disposed between the through hole 311 and the side wall 320, the volume of the first space S1 may be reduced from the volume of the third space S3. As a volume increased amount of the first space S1, which is the front chamber, is reduced, deterioration of the frequency response characteristic of the audio input device 300 may be reduced.

According to an embodiment, a volume of the support 380 may be adjusted based on the size of the diaphragm 330 in order to maintain the volume of the first space S1 constantly. The resonant frequency of the audio input device 300 may be adjusted based on the volume of the first space S1. In order to reduce noise, in a case that the size of the diaphragm 330 is increased, the volume of the first space S1 may be increased. As the volume of the first space S1 is increased, since the resonant frequency of the audio input device 300 gets lower, the frequency response characteristic may be deteriorated. According to an embodiment, the support 380 may maintain the volume of the first space S1 constantly, by occupying a portion of the third space S3 surrounded by the surface 310-1 of the substrate 310, the side wall 320, and the diaphragm 330. For example, in a case that the size of the diaphragm 330 is increased, the volume of the support 380 may also be increased. As the size of the diaphragm 330 is increased, even if the volume of the third space S3 is increased, since the volume of the support 380 may be increased, the volume of the first space S1 may be maintained constantly.

According to an embodiment, the frequency response characteristic of the audio input device 300 may be improved. According to an embodiment, even if the size of the diaphragm 330 and the side wall 320 is increased, since the volume of the front chamber may be reduced, the noise of the audio input device 300 may be reduced and performance may be improved.

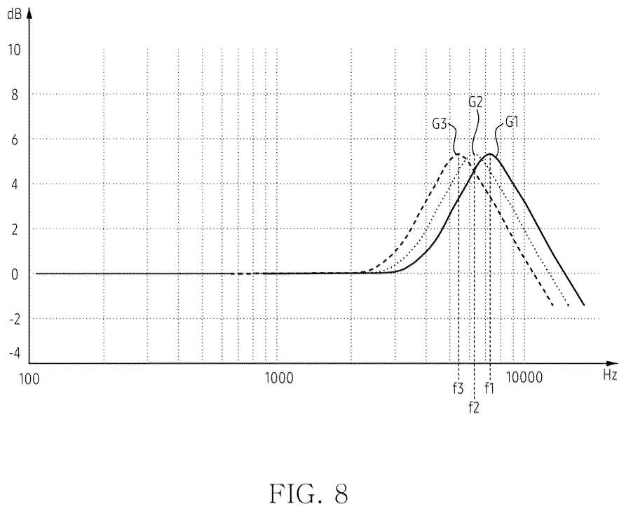

FIG. 8 illustrates frequency response curves according to a volume of a front chamber of an audio input device.

A first graph “G1” of FIG. 8 represents a frequency response curve of the audio input device in which the volume of the front chamber has a first value that is the smallest value. A second graph “G2” represents a frequency response curve of the audio input device in which the volume of the front chamber has a second value that is a value between the first value and the third value. A third graph “G3” represents a frequency response curve of the audio input device in which the volume of the front chamber has a third value that is the largest value.

Referring to FIG. 8, as the volume of the front chamber is increased, a resonant frequency of the audio input device gets lower. As the volume of the front chamber is increased from the first value to the second value, the resonant frequency may get lower from a resonant frequency “f1” of the first graph “G1” to a resonant frequency “f2” of the second graph “G2”. As the volume of the front chamber is increased from the second value to the third value, the resonant frequency may get lower from the resonant frequency “f2” of the second graph “G2” to a resonant frequency “f3” of the third graph “G3”.

In a case that the resonant frequency of the audio input device is reduced, the frequency response characteristic of the audio input device may be deteriorated. For example, in a case that the resonant frequency is reduced, sensitivity designated in a specific frequency band may change, and cause distortion of an audio signal. For example, a width of the frequency band covered by the audio input device may be decreased.

According to an embodiment, based on a duct (e.g., the duct 209 of FIG. 4) and the front chamber, the resonant frequency of the audio input device (e.g., the audio input device 300 of FIG. 4) may be adjusted. A structure of the electronic device (e.g., the electronic device 101 of FIG. 4) may be designed so that the audio input device 300 has the designated resonant frequency. For example, the electronic device 101 may be designed in accordance with the audio input device 300 having the front chamber of a designated volume. In a case that a size of the audio input device 300 disposed in a housing (e.g., the housing 230 of FIG. 4) is changed, the volume of the front chamber may also be changed. For example, in order to reduce noise, the audio input device 300 having a large size of the diaphragm (e.g., the diaphragm 330 of FIG. 4) may be required. As the volume of the front chamber is increased, the resonant frequency of the audio input device 300 may get lower than the designated resonant frequency. In a case that the size of the audio input device 300 is changed, a design change of the electronic device 101 may be required in order to maintain the resonant frequency of the audio input device 300 at the designated resonant frequency. According to an embodiment, even if the volume of the front chamber of the audio input device 300 is increased, the volume of the front chamber may be maintained constantly, by forming a seating groove (e.g., the seating groove 312 of FIG. 4) in a substrate (e.g., the substrate 310 of FIG. 4). According to an embodiment, even if the volume of the front chamber of the audio input device (e.g., the audio input device 300 of FIG. 7A) is increased, the resonant frequency of the audio input device may be maintained substantially constantly through a support (e.g., the support 380 of FIG. 7A). The electronic device 101 according to an embodiment may use the audio input device 300 of the various structure.

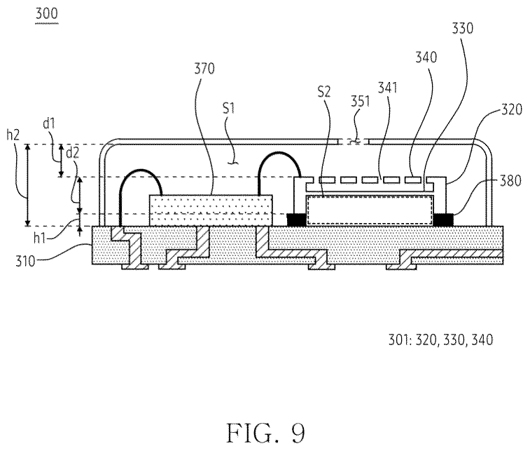

FIG. 9 illustrates an example audio input device.

Hereinafter, an audio input device 300 illustrated in FIG. 9 may be substantially the same as the audio input device 300 described with reference to FIGS. 4, 5A, 5B, and 6 except for descriptions described with reference to FIG. 9. The same reference numeral may be assigned to the same component, and an overlapping description may be omitted.

Referring to FIG. 9, the audio input device 300 may include a substrate 310, MEMS 301, a support 380, and/or a cover 350. The MEMS 301 may include a side wall 320, a diaphragm 330, and/or a plate 340.

According to an embodiment, the side wall 320 may be disposed on a surface 310-1 of the substrate 310. The diaphragm 330 may be supported by the side wall 320, and may be spaced apart from the surface 310-1 in a direction where the surface 310-1 faces. The plate 340 may be supported by the side wall 320 and be spaced apart from the diaphragm 330 in the direction. The plate 340 may include a plurality of holes 341 through which air may flow. The cover 350 may be disposed on the surface 310-1. The cover 350 may surround the side wall 320 and the plate 340.

According to an embodiment, the cover 350 may be disposed on the surface 310-1 of the substrate 310. The cover 350 may surround the side wall 320 and the plate 340. The cover 350 may include an opening 351 through which sound waves transmitted from a microphone hole (e.g., the microphone hole 203 of FIG. 4) may pass. The opening 351 may be connected to the microphone hole 203 through a duct (e.g., the duct 209 of FIG. 4). According to an embodiment, the audio input device 300 may be referred to as a top port type in which an inlet through which sound waves are introduced is formed in the cover 350.

According to an embodiment, the support 380 may be disposed between the surface 310-1 and the side wall 320. The support 380 may support the side wall 320. The side wall 320 may be closer to the cover 350 by a first height h1, which is a height of the support 380. For example, in a case that the support 380 is not disposed, a first distance d1 that is a distance between the plate 340 and the cover 350 with respect to the direction in which the surface 310-1 faces, may be a distance excluding a second distance d2 that is a distance from a bottom surface B of the side wall 320 to the plate 340, from a second height h2 that is a height of the cover 350. According to an embodiment, as the support 380 supports the side wall 320, the first distance d1 may be a distance excluding the first height h1 that is a height of the second distance d2 and the support 380, from the second height h2.

According to an embodiment, the audio input device 300 may include a first space S1 and a second space S2. The first space S1 may be surrounded by components disposed on the surface 310-1 of the substrate 310, the cover 350, and in the cover 350. For example, the first space S1 may be a space excluding a space occupied by the MEMS 301 and/or the support 380 from a space surrounded by the surface 310-1 and the cover 350. For example, the first space S1 may be a space excluding a space occupied by the MEMS 301, the support 380, and/or a signal processing circuitry 370 from the space surrounded by the surface 310-1 and the cover 350. According to an embodiment, in the audio input device 300 of the top port type, the first space S1 may be referred to as a front chamber. A resonant frequency of the audio input device 300 may be adjusted based on a volume of the first space S1. The second space S2 may be surrounded by the surface 310-1 of the substrate 310, the side wall 320, the diaphragm 330, and the support 380. For example, the second space S2 may be a space surrounded by the surface 310-1, the side wall 320, the diaphragm 330, and the support 380. According to an embodiment, in the audio input device 300 of the top port type, the second space S2 may be referred to as a back chamber.

According to an embodiment, the volume of the first space S1 may be decreased from a volume of the front chamber of a case in which the support 380 is not included in accordance with the support 380 disposed between the surface 310-1 and the side wall 320. Since the first distance d1 is reduced by the support 380, a volume of the space occupied by the side wall 320 and the plate 340 may be increased, in a space surrounded by the cover 350. As the volume of the space occupied by the side wall 320 and the plate 340 is increased, the volume of the first space S1 may be decreased. As the volume of the first space S1 is decreased, the resonant frequency of the audio input device 300 may get higher, and frequency response characteristic may be improved.

According to an embodiment, a volume of the second space S2 may be increased from a volume of the back chamber of a case in which the support 380 is not included, in accordance with the support 380 disposed between the surface 310-1 and the side wall 320. Since the height of the second space S2 is a height that adds up the first height h1 and the second distance d2, the height of the second space S2 of the audio input device 300 including the support 380 may be increased by the first height h1, which is the height of the support 380. As the height of the second space S2 is increased, the volume of the second space S2 may be increased. As the volume of the second space S2 is increased, sensitivity of the audio input device 300 may be improved, and a SNR of the audio input device 300 may get higher. According to an embodiment, in the audio input device 300, the volume of the front chamber may be decreased and the volume of the back chamber may be increased, through the support 380 supporting the side wall 320 without a complicated structural change.

According to an embodiment, an electronic device (e.g., the electronic device 101 of FIG. 4) may include a housing (e.g., the housing 230 of FIG. 4), and an audio input device (e.g., the audio input device 300 of FIG. 4). The housing may include a microphone hole (e.g., the microphone hole 203 of FIG. 4). The audio input device may be disposed in the housing. The audio input device may include a substrate (e.g., the substrate 310 of FIG. 4), and micro electro mechanical systems (MEMS) (e.g., the MEMS 301 of FIG. 4). The MEMS may include a side wall (e.g., the side wall 320 of FIG. 4), a diaphragm (e.g., the diaphragm 330 of FIG. 4), and a plate (e.g., the plate 340 of FIG. 4). The substrate may include a through hole (e.g., the through hole 311 of FIG. 4), and a seating groove (e.g., the seating groove 312 of FIG. 4). Sound waves transmitted from the microphone hole may pass through the through hole. The seating groove may be spaced apart from a periphery of the through hole. The seating groove may be dented from a surface (e.g., the surface 310-1 of FIG. 4) of the substrate. The side wall may be disposed on the seating groove of the substrate. The diaphragm may be supported by the side wall of the MEMS. The diaphragm may be spaced apart from the surface of the substrate in a direction where the surface faces. The plate may include a plurality of holes (e.g., a plurality of holes 341 of FIG. 4). The plate may be supported by the side wall of the substrate. The plate may be spaced apart from the diaphragm in the direction. A resonant frequency of the audio input device may be adjusted based on a volume of a space surrounded by the surface of the substrate, the side wall of the MEMS, and the diaphragm of the MEMS. According to an embodiment of the disclosure, in accordance with the side wall disposed on the seating groove, a volume of a front chamber of the audio input device may be limited and a volume of a back chamber of the audio input device may be increased. For example, even if a size of the diaphragm is increased, the volume of the front chamber may be maintained constantly or a volume increased amount of the front chamber may be decreased since a portion of the side wall is inserted into the seating groove. According to an embodiment, since the volume of the front chamber may be limited, frequency response characteristic of the audio input device may be improved, and noise may be reduced.

According to an embodiment, a portion (e.g., the portion 310a of the substrate of FIG. 5B) of the substrate disposed between the seating groove of the substrate and the through hole of the substrate may occupy a portion of a space surrounded by the diaphragm of MEMS and the side wall of MEMS. According to an embodiment of the disclosure, since the portion of the substrate may occupy the portion of the space, the volume of the front chamber of the audio input device may be limited.

According to an embodiment, the audio input device may include a cover (e.g., the cover 350 of FIG. 4). The cover may be disposed on the surface of the substrate. The cover may surround the side wall of the MEMS and the plate of the MEMS. According to an embodiment of the disclosure, the audio input device may be referred to as a bottom port type by the cover that does not include an opening. the cover may surround a back plate.

According to an embodiment, the audio input device may include a first space (e.g., the first space S1 of FIG. 5A), and a second space (e.g., the second space S2 of FIG. 5A). The first space may be surrounded by the surface of the substrate, the side wall of the MEMS, and the diaphragm of the MEMS. The second space may be surrounded by the surface of the substrate, and the MEMS (e.g., the cover, the side wall, and the plate). A volume of the first space is smaller than a volume of a third space surrounded by a bottom surface of the side wall of the MEMS, a lateral surface of the side wall of the MEMS, and the diaphragm, in accordance with the side wall disposed on the seating groove of the substrate. According to an embodiment of the disclosure, the volume of the first space referred to as a front chamber may be limited, in accordance with the side wall disposed on the seating groove of the substrate. Since the volume of the first space is limited, even if a size of the diaphragm is increased, a volume of the front chamber may be limited. According to an embodiment, the frequency response characteristic of the audio input device may be improved, and noise may be reduced.

According to an embodiment, a volume of the second space may be increased, in accordance with the side wall disposed on the seating groove of the substrate. According to an embodiment of the disclosure, the volume of the second space referred to as a back chamber may be expanded, in accordance with the side wall disposed on the seating groove of the substrate. Since a volume of the back chamber may be expanded, sensitivity of the audio input device may be improved, and noise may be reduced.

According to an embodiment, the seating groove of the substrate may surround the through hole of the substrate. The side wall may surround the through hole of the substrate by being inserted into the seating groove of the substrate. According to an embodiment of the disclosure, since the seating groove surrounds the through hole, a space surrounded by the side wall and the through hole may be spatially connected. Sound waves introduced through the through hole may vibrate the diaphragm.

According to an embodiment, the electronic device may further include an adhesive (e.g., the adhesive 360 of FIG. 4). The adhesive may be disposed between the seating groove of the substrate and the side wall of the MEMS. The adhesive may attach the side wall of the MEMS to the seating groove of the substrate. According to an embodiment of the disclosure, the adhesive may be applied on the seating groove on which the side wall is disposed. The adhesive may fix the side wall on the seating groove.

According to an embodiment, a height (e.g., the height h of FIG. 5A) of the seating groove of the substrate may be adjusted based on a size of the diaphragm to maintain a volume of the space constantly. According to an embodiment, in order to reduce noise, the size of the diaphragm may be increased. As the size of the diaphragm is increased, the volume of the front chamber may also be increased. According to an embodiment, in order to limit an increase in the volume of the front chamber, the height of the seating groove may be adjusted. For example, in a case that the size of the diaphragm is increased, the volume of the front chamber may be limited by increasing the height of the seating groove.

According to an embodiment, the housing may include a duct (e.g., the duct 209 of FIG. 4). The duct may transmit sound waves introduced into the microphone hole of the housing to the through hole of the substrate by connecting the microphone hole of the housing and the through hole of the substrate. According to an embodiment of the disclosure, the sound waves may be transmitted from the outside of the electronic device to the audio input device through the duct.

According to an embodiment, the electronic device may further include a PCB (e.g., the PCB 250 of FIG. 4). The PCB may be disposed in the housing. The PCB may be configured to provide an electrical connection between components of the electronic device.

According to an embodiment, the substrate may be disposed on the PCB. The PCB may include a first opening (e.g., the first opening 251 of FIG. 4), positioned at a position corresponding to the through hole of the substrate, connected to the duct of the housing. According to an embodiment of the disclosure, the PCB may electrically connect the audio input device and other components of the electronic device. In order for the audio input device to operate as an audio input device of the bottom port type, the PCB may include an opening connected to the through hole.

According to an embodiment, the audio input device may include a support (e.g., the support 380 of FIG. 6). The support may be disposed on the surface of the substrate in the space. The support may occupy a portion of the space. The support may include a second opening (e.g., the second opening 381 of FIG. 6) positioned at a position corresponding the through hole of the substrate. A volume of the space may be limited by a volume of the support.

According to an embodiment, the support may be integrated with the side wall of the MEMS.

According to an embodiment, the volume of the support may be adjusted based on a size of the diaphragm to maintain the volume of the space constantly. According to an embodiment of the disclosure, the support may limit the volume of the front chamber. In a case that the size of the diaphragm is increased, as the volume of the support is increased, the volume of the front chamber may be limited.

According to an embodiment, the electronic device may further include a processor (e.g., the processor 120 of FIG. 1). The processor may be operatively connected to the audio input module. The processor may be configured to obtain an audio signal based on a change in electrostatic capacitance between the diaphragm of the MEMS and the plate of the MEMS.

The audio input module may include signal processing circuitry (e.g., the signal processing circuitry 370 of FIG. 4). The signal processing circuitry may be configured to generate the audio signal based on the change in the electrostatic capacitance. The signal processing circuitry may be configured to transmit the generated audio signal to the processor. According to an embodiment of the disclosure, the audio input device may be configured to generate an audio signal based on a vibration of the diaphragm. The generated audio signal may be transmitted to the processor through the PCB.

According to an embodiment, an electronic device (e.g., the electronic device 101 of FIG. 4) may include a housing (e.g., the housing 230 of FIG. 4), and an audio input device (e.g., the audio input device 300 of FIG. 7A). The housing may include a microphone hole (e.g., the microphone hole 203 of FIG. 4). The audio input device may be disposed in the housing. The audio input device may include a substrate (e.g., the substrate 310 of FIG. 7A), and micro electro mechanical systems (MEMS) (e.g., the MEMS 301 of FIG. 7A). The MEMS may include a side wall (e.g., the side wall 320 of FIG. 7A), a diaphragm (e.g., the diaphragm 330 of FIG. 7A), a plate (e.g., the plate 340 of FIG. 7A), and a support (e.g., the support 380 of FIG. 7A). The substrate may include a through hole (e.g., the through hole 311 of FIG. 7A). Sound waves transmitted from the microphone hole may pass through the through hole. The side wall may be disposed on a surface (e.g., the surface 310-1 of FIG. 7A) of the substrate. The diaphragm may be supported by the side wall of the MEMS. The diaphragm may be spaced apart from the surface of the substrate in a direction where the surface faces. The plate may include a plurality of holes (e.g., a plurality of holes 341 of FIG. 7A). The plate may be supported by the side wall of the substrate. The plate may be spaced apart from the diaphragm in the direction. The support may be disposed between the through hole and the side wall on the surface. The support may occupy a portion of a space between the diaphragm and the surface. The support may include an opening (e.g., the opening 318 of FIG. 7A) positioned at a position corresponding the through hole of the substrate. A resonant frequency of the audio input device may be adjusted based on a volume of a space surrounded by the surface of the substrate, the side wall of the MEMS, the diaphragm of the MEMS, and the support. According to an embodiment of the disclosure, in accordance with the support disposed between the through hole and the side wall, a volume of a front chamber of the audio input device may be limited and a volume of a back chamber of the audio input device may be increased. For example, even if a size of the diaphragm is increased, the volume of the front chamber may be maintained constantly or a volume increased amount of the front chamber may be decreased since the support occupy a portion of a space in the side wall. According to an embodiment, since the volume of the front chamber may be limited, frequency response characteristic of the audio input device may be improved.

According to an embodiment, the support may be integrated with the side wall of the MEMS. According to an embodiment of the disclosure, the support may be a portion of the side wall. The side wall may be stably disposed on the substrate by the support.

According to an embodiment, the audio input device may include a cover (e.g., the cover 350 of FIG. 7A), a first space (e.g., the first space S1 of FIG. 7A), a second space (e.g., the second space S2 of FIG. 7A), and a third space (e.g., the third space S3 of FIG. 7A). The cover may be disposed on the surface. The cover may surround the side wall of the MEMS and the plate of the MEMS. The first space may be surrounded by the side wall of the MEMS, the diaphragm of the MEMS, and the support. The second space may be surrounded by the surface of the substrate, the cover, and the MEMS (e.g., the side wall, and the plate). A volume of the first space is smaller than a volume of a third space surrounded by a bottom surface of the side wall of the MEMS, a lateral surface of the side wall of the MEMS, and the diaphragm, in accordance with the support disposed between the through hole and the side wall of the MEMS. According to an embodiment of the disclosure, the first space may be referred to as the front chamber. The volume of the front chamber may be a volume excluding a volume of the support in the space in the side wall. According to an embodiment, the volume of the first chamber referred to as the front chamber may be limited by the support. In order to reduce noise, in a case that the size of the diaphragm is increased, the volume of the front chamber may be maintained constantly or the volume increased amount of the front chamber may be decreased, by the support. According to an embodiment, since the volume of the front chamber may be limited, the frequency response characteristic of the audio input device may be improved, and noise may be reduced.

According to an embodiment, the volume of the support may be adjusted based on a size of the diaphragm to maintain the volume of the space constantly. According to an embodiment, in order to reduce noise, the size of the diaphragm may be increased. As the size of the diaphragm is increased, the volume of the front chamber may also be increased. According to an embodiment, in order to limit an increase in the volume of the front chamber, the volume of the support may be adjusted. For example, in a case that the size of the diaphragm is increased, the volume of the front chamber may be limited by increasing the volume of the support.

According to an embodiment, the housing may include a duct (e.g., the duct 209 of FIG. 4). The duct may transmit sound waves introduced into the microphone hole of the housing to the through hole of the substrate by connecting the microphone hole of the housing and the through hole of the substrate. According to an embodiment of the disclosure, the duct may connect the through hole and the microphone hole. The resonant frequency of the audio input device may be adjusted based on a volume of the duct and the volume of the front chamber.

According to an embodiment, an electronic device (e.g., the electronic device 101 of FIG. 4) may include a housing (e.g., the housing 230 of FIG. 4), and an audio input device (e.g., the audio input device 300 of FIG. 9). The housing may include a microphone hole (e.g., the microphone hole 203 of FIG. 4). The audio input device may be disposed in the housing. The audio input device may include a substrate (e.g., the substrate 310 of FIG. 9), and micro electro mechanical systems (MEMS) (e.g., the MEMS 301 of FIG. 9). The MEMS may include a side wall (e.g., the side wall 320 of FIG. 9), a diaphragm (e.g., the diaphragm 330 of FIG. 9), and a plate (e.g., the plate 340 of FIG. 9), a support (e.g., the support 380 of FIG. 9), and a cover (e.g., the cover 350 of FIG. 9). The side wall may be disposed on a surface (e.g., the surface 310-1 of FIG. 9) of the substrate. The diaphragm may be supported by the side wall of the MEMS. The diaphragm may be spaced apart from the surface of the substrate in a direction where the surface faces. The plate may include a plurality of holes (e.g., a plurality of holes 341 of FIG. 9). The plate may be supported by the side wall of the substrate. The plate may be spaced apart from the diaphragm in the direction. The support may be disposed between the surface and the side wall. The cover may be disposed on the surface of the substrate. The cover may include an opening (e.g., the opening 351 of FIG. 9) through which sound waves transmitted from the microphone hole pass. The cover may surround the side wall of the MEMS and the plate of the MEMS. A resonant frequency of the audio input device may be adjusted based on a volume of a space surrounded by the surface of the substrate, the MEMS (e.g., the side wall, and the plate), the support, and the cover.

According to an embodiment, the volume of the space may be decreased in accordance with the support disposed between the surface and the side wall. According to an embodiment of the disclosure, an audio input device of a top port type may include a cover including an inlet through which sound waves are introduced. In the audio input device of the top port type, a front chamber may be a space surrounded by the surface, the side wall, the plate, the support member, and the cover. A volume of the front chamber may be limited, in accordance with the support disposed between the substrate and the side wall. According to an embodiment, since the volume of the front chamber may be limited, frequency response characteristic of the audio input device may be improved, and noise may be reduced.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server. According to one or more embodiments, each component (e.g., a module or a program) of the above-described components may include a single entity or multiple entities, and some of the multiple entities may be separately disposed in different components.

According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a housing comprising a hole; and
an audio input device, disposed in the housing, comprising a substrate and micro electro mechanical systems (MEMS),
wherein the substrate comprises:
a through hole through which sound waves transmitted from the hole of the housing pass, and
a seating groove that is spaced apart from a periphery of the through hole, the seating groove being dented from a surface of the substrate, and
wherein the MEMS comprises:
a side wall disposed on the seating groove of the substrate,
a diaphragm supported by the side wall of the MEMS and spaced apart from the surface of the substrate in a direction where the surface faces, and
a plate comprising a plurality of holes, the plate being supported by the side wall of the substrate and spaced apart from the diaphragm in the direction, and
wherein a resonant frequency of the audio input device is adjusted based on a volume of a first space surrounded by the surface of the substrate, the side wall of the MEMS, and the diaphragm of the MEMS.

2. The electronic device of claim 1, wherein a portion of the substrate between the seating groove of the substrate and the through hole of the substrate occupies a portion of the first space surrounded by the diaphragm of MEMS and the side wall of MEMS.

3. The electronic device of claim 1, wherein the audio input device further comprises a cover, disposed on the surface of the substrate, surrounding the side wall of the MEMS and the plate of the MEMS.

4. The electronic device of claim 3, wherein the audio input device further comprises:
the first space, and
a second space surrounded by the surface of the substrate, the cover of the audio input device, and the MEMS, and
wherein a volume of the first space is smaller than a volume of a third space surrounded by a bottom surface of the side wall of the MEMS, a lateral surface of the side wall of the MEMS, and the diaphragm.

5. The electronic device of claim 4, wherein a volume of the second space is increased as the side wall is inserted into the seating groove of the substrate.

6. The electronic device of claim 1, wherein the seating groove of the substrate surrounds the through hole of the substrate, and
wherein the side wall surrounds the through hole of the substrate by being inserted into the seating groove of the substrate.

7. The electronic device of claim 1, further comprising an adhesive between the seating groove of the substrate and the side wall of the MEMS,
wherein the adhesive attaches the side wall of the MEMS to the seating groove of the substrate.

8. The electronic device of claim 1, wherein a volume of the first space is maintained constantly by adjusting a height of the seating groove of the substrate based on a size of the diaphragm.

9. The electronic device of claim 1, wherein the housing further comprises a duct configured to transmit sound waves introduced into the hole of the housing to the through hole of the substrate by connecting the hole of the housing and the through hole of the substrate.

10. The electronic device of claim 9, further comprising a printed circuit board (PCB) disposed in the housing,
wherein the substrate is disposed on the PCB, and
wherein the PCB comprises a first opening, the PCB being positioned at a position corresponding to the through hole of the substrate and being connected to the duct of the housing.

11. The electronic device of claim 1, wherein the audio input device further comprises a support that: is disposed on the surface of the substrate, occupies a portion of the first space, and comprises a second opening positioned at a position corresponding the through hole of the substrate, and
wherein a volume of the first space is decreased by a volume of the support.

12. The electronic device of claim 1, wherein the support is integrated with the side wall of the MEMS.

13. The electronic device of claim 1, wherein the volume of the first space is maintained constantly by adjusting the volume of the support based on a size of the diaphragm.

14. The electronic device of claim 1, further comprising:
a processor comprising processing circuitry; and
memory comprising one or more storage mediums storing instructions,
wherein the instructions, when executed by the processor, cause the electronic device to obtain an audio signal based on a change in electrostatic capacitance between diaphragm of the MEMS and the plate of the MEMS.

15. The electronic device of claim 14, wherein the audio input device further comprises signal processing circuitry configured to generate the audio signal based on the change in the electrostatic capacitance, and
wherein the signal processing circuitry is configured to:
generate the audio signal based on the change in the electrostatic capacitance, and
transmit the audio signal to the processor.

16. An electronic device comprising:
a housing comprising a hole;
an audio input device comprising a substrate and micro electro mechanical systems (MEMS);
wherein the substrate comprises a through hole through which sound waves transmitted from the hole of the housing pass, and
wherein the MEMS comprises:
a side wall disposed on a surface of the substrate,
a diaphragm, supported by the side wall of the MEMS, spaced apart from the surface of the substrate in a direction where the surface faces,
a plate comprising a plurality of holes, the plate being supported by the side wall of the substrate and spaced apart from the diaphragm in the direction, and
a support between the through hole and the side wall on the surface, the support occupying a portion of a space between the diaphragm and the surface of the substrate and the support comprising an opening positioned at a position corresponding the through hole of the substrate, and
wherein a resonant frequency of the audio input device is configured to be adjusted based on a volume of a space surrounded by the surface of the substrate, the side wall of the MEMS, the diaphragm of the MEMS, and the support.

17. The electronic device of claim 16, wherein the support is integrally formed with the side wall.

18. The electronic device of claim 16, wherein the audio input device further comprises:
a cover, disposed on the surface of the substrate, surrounding the side wall of the MEMS and the plate of the MEMS,
a first space defined by the side wall, the diaphragm, and the support, and
a second space defined by the surface of the substrate, the cover, and the MEMS, and
wherein a volume of the first space is smaller than a volume of a third space surrounded by a bottom surface of the side wall of the MEMS, a lateral surface of the side wall of the MEMS, and the diaphragm.

19. The electronic device of claim 16, wherein the volume of the space is maintained constantly by adjusting a volume of the support based on a size of the diaphragm.

20. The electronic device of claim 16, wherein the housing further comprises a duct configured to transmit the sound waves introduced into the hole of the housing to the through hole of the substrate, by connecting the hole of the housing and the through hole of the substrate.
